(19) United States
(12) Patent Application Publication
(10) Pub. No.: US 2004/0254814 A1
(43) Pub. Date: Dec. 16, 2004

(54) Scheduling, filing and tracking system for breast, prostate and colorectal cancer screening

(76) Inventor: Sumathi Paturu, Pleasant Grove, AL (US)

Correspondence Address: DR. SUMATHI PATURU, MD., 207, BROOKE-LYN TERRACE., PLEASANT GROVE, AL, 35127, US

(21) Appl. No.: 10/460,788

(22) Filed: Jun. 13, 2003

(51) Int. Cl. G06F 1/00

(52) U.S. Cl. 705/2

(57) ABSTRACT

Cancer screening is a very important aspect of practice management. How ever there is no efficient cancer tracking systems existent so far, though there is screening protocols devised by the American cancer society for most of the commonly occuring cancers. The breast, prostate and colorectal cancer scheduling, tracking and filing described here in, is the simplest, economical, and the most efficient cancer tracking system that can be practiced both in the urban and rural settings and in the small and large practices, and it is also unique in that, three cancer screenings are being done in one filing, making it very convenient both for the patient and the health care providers.

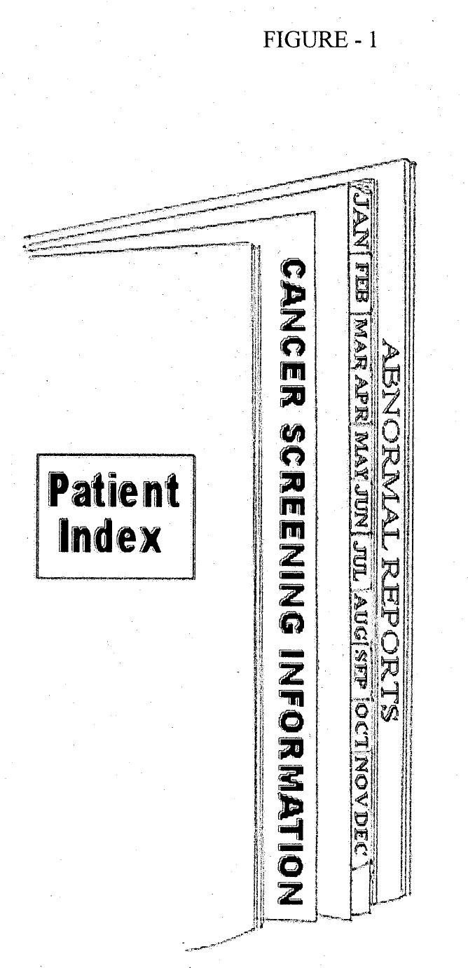

### BACKGROUND

Cancer is one of the leading causes of death in America. The most important are the breast, cervix, prostate, and colorectal cancers, for which good screening procedures are available. In this instructional manual of cancer screening, we are dealing with the scheduling, filing and tracking of breast, prostate and colorectal cancers, which are integrated, as the screening for all these cancers start at age 50+.

Colorectal cancer is the second leading cause of cancer death. There are 130,000 new cases and 56,000 new deaths each year. 30% of men over 50, and 46% of men over 70, have histologic prostate cancer, and 1 of every 9 women in US will develop breast cancer. The breast cancer is the second leading cause of cancer death among women, with 180,000 new cases, and 45,000 deaths each year. Good screening procedures and protocol guidelines are existent for many years set up by American cancer society. But all of us should agree that these health maintenance protocols are not put into practice as often and as strictly as they should be. Patient ignorance and non-compliance are significant causes. Stress, overwork and constraints of time would take the brunt even on the most conscientious physician, and the health maintenance protocols are so many that the time required amounts to be a burden. If a patient ends up with cancer, and if the physician is recognized as the only physician involved in the care, the patient is going to hold the physician as responsible for not doing that simple screening test for an early detection. In busy practices where patients come with acute and chronic pathology, the issue of health maintenance becomes a point of lesser importance. The doctor is the busiest person in the clinic and yet also happens to be the person who should look into these health maintenance issues, and given the 10-20 minutes clinic time, the physician has to look into—if the patient had a PAP smear & mammogram/PSA scheduled, colorectal cancer screening done, blood sugar monitored, and cholesterol level checked.

Most of the charts (or the clinics) have health maintenance flow sheets but who ever had used them are sure to figure out how difficult it is to look into these issues for each and every patient and yet deliver the quality health care for the problems the patients have come for. And realization and acceptance of this problem yet would not relieve the burden of responsibility from the shoulders of the primary care physicians. So it is time to think of some other ways to deliver these health care issues in a diligent way with out diluting the other aspects of health care in a given time frame. There is only one way to do that. Think of not only having a health maintenance flow sheet in the chart but also having separate filing with very clearly set up guidelines for each screening protocol so that it is more than just the doctor who is involved in the implementation of these protocol guidelines. Think of the model that is already there in the regional county health departments, where the PAP smears and childhood immunizations are being done by paramedical personnel, just by following the already setup clinical protocols and guidelines and having annual or semiannual audits to make sure they are being followed up without compromise. A similar model can be setup in the clinics, and health maintenance can be delivered easily and more effectively by shared responsibility. In other words, this care should start at the very first encounter, even before the patient gets into the examination room. Documentation of these test results and dates are done in the flow sheet of the chart, but facilitation of this should be done also outside the chart, and outside the patient's room.

If the patients don't come themselves for annual physical or if there is no tracking system, it is hard to figure out from the patient pool the 50+year olds and call them for these tests (or annual physicals), as per the screening guide lines.

### BRIEF DESCRIPTION OF THE FILING

The breast/prostate and the colorectal cancer screening filing system is comprised of the breast/prostate cancer filing system functioning separately from the colorectal cancer screening system, but both contained in the same file, for many practical conveniences, and both the systems are similar in the way they function, and one screening table i.e. the ‘colorectal, breast and prostate screening protocol’, containing both the breast/prostate, and colorectal cancer screenings, is used in both the divisions of the file, but only the relevant table in the page is used for either screening section, and one page is totally allotted to one patient.

See the schematic model of the file, FIG.—1, to understand how the file is devised. The breast/prostate and colorectal cancer screening is comprised of 3 divisions

1. PATIENT INDEX,

2. CANCER SCREENING INFORMATION, and

2. ABNORMAL REPORTS.

1. Patient Index

Contains the patient names in alphabetical order A-Z, and who ever had screening done, and logged into the file, their names have to be immediately entered into the patient index, as per the alphabetical group, showing the page number of the record, and the month it is filed in (as month/day, like we write the date), and noting this way in the patient index is the only way to locate the patient record at any time.

See the patient index table 3, for alphabetical group A, in page 32.

2. Cancer Screening Information

This is the filing division where the patient's cancer screening records are filed in the 12 months, January-December, and as per the month of the appointment given, or the previous cancer screening done, with the appointment date noted with a pencil, as the page number in the right upper corner of the page. Whenever the appointment changes, the page number can be changed, and the record is moved into that month, and the appointment date marked as the new page number. On any current month, only the records filed into that month is focused on, for the purposes of screening, tracking and rescheduling, and who ever misses the appointment, can be figured out on the same day for rescheduling and, thus the file has an inbuilt tracking system that is very efficient, and the file works like a cyclical perpetual calendar, the pages of which changes every 5 years.

See the Table-2, the typical cancer screening table, that has the colorectal cancer screening protocol in the upper half, and the breast/prostate screening in the lower half, with the patient's personal data documented in the top.

3. Abnomal Reports

It is the section to document the abnormal cancer screen reports to have a special focus on, until the definitive treatment is done, and also to monitor after for recurrence.

As this is an instructional manual, it is also supplied with a ‘file compilation’ section that has the tabs, file dividers and the tables, to construct the file, as it is impractical for a busy practitioner to do these on his own, as some of the tables are complex, and time taking to design.

How to Get Started

There must be a radical change in the operational system of the ambulatory care clinics. The reason is, the existing system is not working.

It is a good idea to have filing system for every health maintenance issue that the ambulatory care physicians are responsible for. The filing system should have built in tracking system to reach all the patient population every year, as per the screening protocols and the system about to be described is simple, not time consuming and easy to implement.

However in the beginning when you try to prepare the file and enroll the patients, it takes time, effort and motivation and it may take few months to one year. After that, it is only an issue of its maintenance. To enroll the patients into the logging and tracking system, you should generate a computer list of all the patients' names with ages and select the patients aged 50 and above from that list.

For the colorectal cancer screening it involves FOBT every year, and sigmoidoscopy (or double contrast barium enema) every 5 years starting age 50, or colonoscopy every 10 years.

For the prostate cancer screening, it is digital rectal exam (DRE) and PSA levels every year starting age 50.

And for the breast cancer screening it is annual breast exam, and mammogram for all females starting age 50.

Look at the table-1 in the following page for American cancer society guidelines for breast, prostate and colorectal cancer. A copy of this has to be kept in the front of the file, and it should be read by all the staff members.

The doctor has to assume responsibility of educating them, and during lunch can quiz them to know if they have thorough understanding of the protocol, because they are participating in a very important way in implementation of these protocols in the clinics.

The filing system not only documents the cancer screening in the file but also has an inbuilt tracking system that implements itself every month of the year on an ongoing basis. It enables you to focus your attention on those patients who have to come in every month at their due time of appointments.

To start with, find out how many 50+years old patients you have from your computer listing and decide what time frame you need to tackle the whole list (few months to 1 year). You can figure out the average number of patients you can or want to deal with every month. This is the target population you need to call, schedule and enter into the file every month.

Call everyday (who ever has, and whenever there is free time) in a serial order from the list for annual physical, or the relevant cancer screening tests and explain their importance for early detection of cancer. You find most of the patients to be cooperative and happy to come in. Majority of patients are interested in cancer detection, even if they are not interested in other issues. Explain to them the prerequisites like avoiding red meat, aspirin and non steroidal anti-inflammatory medications and schedule an appointment. Enter these patients' names into the logbook.

If the patient can't come in, mail 2-3 of fecal occult blood cards with instructions, and ask them to return immediately after using them (they can mail back). It is very cost effective. If patient is due for endoscopy, schedule the appointment for that, and enter the patient's name in the file.

The very first time the patient entered, provide them with a hand out of information about colorectal cancer (risk factors, preventive measures and the screening protocol you are trying to implement). Knowing the protocol makes them aware what to expect. Just like knowledge is power, knowledge is also the key for patient compliance. So if you want the patient to be compliant, make them more knowledgeable about the issue that the whole clinic is working so hard for. It is a good idea to send material also for people to whom you have mailed the cards. You can also enter the patients who come into the clinic and fall into this age group.

If you make it a rule in the clinic that every patient has to go through this logging system (just like the pulse and the BP being checked), before being put into the room, you can catch lot of eligible patient pool.

TABLE 1
THE AMERICAN CANCER SOCIETY RECOMMENDATIONS
FOR THE EARLY DETECTION OF CANCER IN
SK ASYMPTOMATIC PEOPLE.

| CANCER SITE | POPULATION | TEST OR PROCEDURE | FREQUENCY |
|---|---|---|---|
| Colorectal | Men and women | Fecal occult blood testing & Flexible | Annual fecal occult blood testing & |
| | age 50+ | Sigmoidoscopy | Flexible Sigmoidoscopy at age 50; |
| | | | Thereafter FOBT every year |
| | | | and Flexible Sigmoidoscopy every |
| | | | 5 years. |
| | | OR | |
| | | Double Contrast Barium enema. | At age 50; Thereafter every 5-10 |
| | | | years. |
| | | OR | |
| | | Colonoscopy | Colonoscopy every 10 years staring |
| | | | at age 50. |
| Breast | Women aged | Clinical breast exam. (CBE) and | Screening every 1-2 years with |
| | 50-65 | mammography | mammography + CBE for women |
| | | | aged 50-69 |
| Prostate | Men age 50+ | Digital Rectal exam. (DRE) and Prostatic | Both annually starting at age 50+ |
| | | Specific antigen test (PSA) | |

If you make it like a rule in the clinic that every patient has to go through this logging system (just like pulse and the BP are being checked) before being put into the room, you can catch lot of eligible patient pool.

And if you come across an eligible patient chart with no screening done, call these patients and ask if they had screening done elsewhere. If they wish to continue future screenings in your clinic and the last screening was done in less than a year, confirm the month and give an appointment for that month and file the records into that month. If it is past due, give them appointments at an earliest date. So also for the patients who never had any screening at all. You should also concentrate on the patients who have current appointment dates and schedule them immediately.

How the file works needs some mention here. Reference was already made about the ‘Schematic model of the file’, FIG.—1, and the cancer screening table 2. As I stated already, depending upon the month when the cancer screening procedures are due, the patients' records are filed in that month. Each patient is allotted one total page. The previous clinic appointment dates (for screening tests to be done in the clinic like PSA/BE, DRE and FOBT) serve as the page numbers of the record in that month (being 1-31, the dates of the month) the specifics of which will be discussed in detail in the appropriate section. After the initial filing into each month along with the page numbers is complete, you have to arrange the page numbers of each month section into the right serial order. When the month becomes current, you should call and confirm the appointments that also happen to be the page numbers. If the appointment date happens to become different, change the page number and move it to the corresponding section of the same month or the following month. Use a pencil or erasable ink pen to mark page numbers. Make note the heading in the top of the patient's record or the file dividers or tabs don't document the YEAR because this file behaves like a perpetual calendar (with life span of 5 years average to each page) that you come back to, every month of the year to work on the same set of patients on their due appointment dates.

At the end of the text, there is a ‘file compilation’ section, that has the tabs, file dividers, and tables, that are helpful in making the file.

[image]

### DRAWINGS

FIGURE—I

The schematic model of the file.

### THE DETAILED DESCRIPTION OF THE FILING

### The File, the Protocol and the Format

The cancer screening system has separate colorectal cancer screening file and breast/prostate cancer screening file, but in the same log book. However the model of filing and the format are identical. As you must have noted already, only one file is shown in the schematic picture. However when you make the logbook you have to make two similar files of the model shown. Each cancer screening division is comprised of three parts.

1) PATIENT INDEX,

2) CANCER SCREENING INFORMATION,

3) THE ABNORMAL REPORTS.

As already mentioned that the model of filing and the format are identical, the following information applies to both the cancer screening files.

1. PATIENT INDEX—This is the first division of the file. The patient index has alphabetical pages A-Z (See the typical patient index table-3. As soon as the patient entered into the file and assigned page number, it has to be noted in the patient index (month first and page number later like we write the date, no year). I am going to describe more about this at the very end when you understand the relevance of the information better, than at present.

2. CANCER SCREENING INFORMATION—This is the second part of the file. It contains 12 tabs i.e. January-December, and so divided into 12 sections. Each section of the month contains the names of patients who were (are) scheduled for (and/or done) colorectal cancer screening and breast/prostate cancer screening during that month. The format these pages are made up of, needs detailed description.

### The Protocol Format

Each patient is allotted one page in each cancer screening section. The protocol table of each page has provision to screen all the recommended procedures for both colorectal and breast/prostate cancer screening. Refer to the format in table-2. The upper half of the table is for colorectal cancer screening and the lower half for breast/prostate cancer screening. As you can understand you are using only the relevant table in each section.

On the top there is space to write patient data—name, address (you can prefer to write down the address when the patient keeps up the appointment also), DOB and work & home phone numbers. The first vertical column is to fill in the ‘Dates of the last cancer screening’ for both the cancer screening tables. After you fill in this data, make a photocopy and file in each section. The way it is devised saves you time. You can fill in one cancer screening protocol page for any given patient, but can use it for both the cancer screening files. That means in the given time it takes to make one file, you are making two files.

### Colorectal Cancer Screening

Refer to the cancer screening table-2, and make note that the headings in the top of the colorectal cancer screening table do not apply for breast/prostate screening table below. To avoid repetition, there is information included about breast/prostate cancer screening also in few places of this section

The colorectal cancer screening table is made up of

Vertical Columns

1) The First Column is for the dates of the last screening procedures, FOBT, and endoscopy (and BE, DRE, and PSA for breast/prostate cancer screening) There is also space if you want to add any important information other than the dates, from the previous screening. You should also enter the patient's age when the most recent endoscopy was done. This space stays empty if no screening was done earlier.

2) The Second Vertical Column is wider and has information about cancer screening tests. It is again divided into 6 columns. The first one has screening information for all the cancer screening procedures—like the dates they are scheduled, done and the results. It is followed by 5 vertical columns, meant for 5 years of cancer screening.

The first and bigger vertical column is for FOBT and Endoscopy. So it is divided into 2 because you may want to do FOBT in the clinic before scheduling for Endoscopy. Some patients may like to have only one done. The Endoscopy column can cover Sigmoidoscopy, Colonoscopy or double Contrast Barium Enema. The screening protocol starts with Endoscopy at age 50 or more (if you are seeing the patient for the first time and if Endoscopy was not done earlier for the age 50+patients). If the 50+old patients had Endoscopy already within the past 5 years, skip this column and go to FOBT column.

The Last Four Columns—are for FOBT alone, every year following Endoscopy. Use column 2,3,4 or 5 depending upon which year it is from the preceding Endoscopy, so that next Endoscopy (5 years later) will not be missed when it is due.

The Last transitional column—of the table is meant to prompt you to read the text about changing to new page (described in detail later).

HORIZONTAL COLUMNS—Each cancer screening table has 4 horizontal columns.

1. The First Column—(Scheduling)

You can have 4 types of encounters during scheduling.

(S)—Scheduled—if you successfully scheduled the patient.

(R)—Refused—Even after few efforts, if patient refuses screening (and not interested to do FOBT cards by mail also), note as (R).

(CM)—Cards mailed—If patient agrees, mail 3-4 cards, and note as cards mailed. Ask the patient to date the cards when he uses them and return in 1 week.

(RV)—Random Visits—These are the patients who come in for regular clinic visits and have screening procedures done. They can also be previously missed or non-complaint appointments.

So note as (S), (R), (CM) or (RV) depending upon the nature of the encounter.

2. The Second Column—(Scheduled date)

In this column you mention the date when the screening procedure is scheduled. Some times the patients cancel the appointments and rescheduling can be a prolonged process especially for old and non-compliant patients. In all these situations you have space in back of the page to document what ever you have done (you can note down other types of information also in the back of the page).

How ever, in the table itself you have space for 2-3 appointment dates. So start writing the dates on the very top of the space, so you can add other dates if necessary in the bottom. Highlight the missed appointments with one particular color through out the file.

You can put (R) for patients who refused screening in the very beginning. For others who had few appointments and missed them and you could not make them compliant, note (R) next to the date you confirmed non-compliance. For mailing the FOBT cards (CM), note the date you mailed the cards.

3. Third column (date done)

Enter the date when any screening procedure was done. Document as (M) for missed appointments even after few reschedulings.

For the cards mailed, put the date the last (or the positive FOBT) card was done.

4. Fourth Column (Results)

Enter—(N) for Normal

(AB) for Abnormal

There is some space for a brief note for an abnormal report. It could be simple like ‘polyp’ or ‘Malignancy’. You can use the back of the page also to write about abnormal reports (brief note). There is a section for abnormal reports also in the back of the file for each cancer screening (colorectal, breast or prostate) where you can write detailed report. You can use (N) or (AB) for endoscopy, mammogram, BE, DRE and also for PSA. However for PSA you can mention elevate PSA level within brackets next to (AB). You can highlight AB with similar color throughout the.

| | |
|---|---|
| For FOBT mention as | (+) for Positive Fecal occult blood |
| | (−) for negative fecal occult blood |

There is a summary of abbreviations, which every body must be well acquainted with.

The Column for ‘Age’

This horizontal column is in the top of the table. Noting down the age during every visit for cancer screening is important. The idea is to focus attention on the age, not the number of the visit. The situation can be misleading for non-compliant patients. Suppose the patient had endosopy at age 50 and comes again at age 54, you have to use column 5 of the FOBT. You can't use the column of FOBT that is next to endoscopy (column 2) because it is his first FOBT after endoscopy. The idea is not to miss scheduling endoscopy again 5 years later, which could be missed if you don't tabulate this way. However there is ‘endoscopy reminder’ (described later) that prompts you also. This type of situation (missing years) may not happen from the second visit onwards after the patient is enrolled into the file, because you are going to call these patients and fill the columns every year even for non-compliant patients. It is the first enrollment that would pose a problem. Make note there is a provision to mention age next to endoscopy in the column for ‘Dates of last screening’. Mention age of the patient in every column to go to the right column of FOBT. If the patient had endoscopy 5 yrs ago and comes to your clinic and gets enrolled, you are using the column 1 i.e. FOBT+endoscopy because he is due for endoscopy now. You are also starting column 1 for endoscopy 5+years ago, because he is over due for endoscopy. If the last screening of endoscopy is less then 5 years ago, to get to the right Column of FOBT, mention the age of previous endoscopy in column 1, and then continue to the rest of the columns adding 1 year to the age in each column, to get to the right column of FOBT.

### Breast/Prostate Cancer Screening Table

The breast/prostate cancer screening table is similar in that you document the dates of last screening in the first vertical column to guide you when to schedule these screenings in the current year.

The way you tabulate for all the four horizontal columns (scheduling, scheduled date, date done, and results) is similar to colorectal cancer screening. In these columns round off which screening procedure applies to that particular patient—either D (Digital rectal exam) and P (PSA) in the case of a male, or B (Breast exam), and M (mammogram) for a female.

The table has provision to document 5 years of cancer screening in the spaces provided, for all the screening tests included in the protocol guide lines, every year. As already stated, there is no mention of the month or the year on the top of the table, as it can be understood it is not necessary, but the dates of all the proceedings of the cancer screenings are mentioned in the columns of the table, and the file tabs of the month dividers are to help the filing and tracking of these screenings.

Summary of abbreviations to be used in the cancer screening table,
every body has to be familiar with. Keep a copy of this in the front of
the “Cancer Screening Information” section of the file.

| | |
|---|---|
| 1. ‘Scheduling’ | (S) - If the appointment is scheduled. |
| and | Put the date- in the second column. |
| 2. ‘Scheduled date’ | (R) - If the patient refuses any screening. |
| | Date in the second column- the day you confirm |
| | non-compliance. |
| | (CM) - Cards mailed for FOBT. |
| | Date the day you mailed- in the second column. |
| | (RV) - Random Visits - Date the day you did any screening. |
| | Date scheduled and done would be the same for FOBT, PSA, |
| | DRE & BE. |
| 3. ‘Date done’ | Enter the date, on which any screening was done. |
| | (MA) - For missed appointments. |
| | For CM - enter the date of the last FOBT done by the patient, |
| | or the date of positive (+) FOBT, if any. |
| 4. ‘Results’ | (N) - For normal & For endoscopy, DRE, BE, mammography |
| | and PSA |
| | (AB) - for abnormal |
| | (+) - For positive FOBT |
| | (−) - For negative FOBT |

### How do You Coordinate the Appointments For Noncompliant Patients During the Random Visits

The filing works as planned for all the compliant, patients but if they miss few appointments and the only recourse is to try the following year, they are lost in the system. How do you find them when the opportunity presents during random visits.

To facilitate that there should be some changes in the pro-format of your daily progress notes. On the top, where the nurses enter the vitals, wt. and other relevant information, add a column for ‘Health maintenance’.(HM). It can be very simple as follows:

Health Maintenance

| | | |
|---|---|---|
| Cancer Screening | Breast | |
| | Colorectal | Feb. 1, 2001 |
| | Prostate (PSA) | |

For women use the top two and for men use the bottom two. The nurse should enter during each visit when these cancer screenings were done the last time. To find this information, with out wasting the time of referring the whole chart again, you need to

1. Refer the screening file for each and every patient, even to figure out if the patient is non compliant, if the patient does not remember the dates, or not interested to provide the information. As I mentioned already each and every body has to go through the filing system, before getting into the examination room, or

2. While you are preparing the cancer screening table, when you are entering the dates of the last screening in the table, do the same in an empty progress notes sheet also, under the health maintenance column (it is easier to have a stamped imprint until they are printed into the new progress notes), and file it into the chart, and once written in the progress notes, subsequent entries are easier, because it only has to be copied from the previous progress notes.

Any time you realize the date is over one year, round it off and prepare that patient for cancer screening. Patients can also have time to think and decide if they want to get the screening done before the doctor enters the room. You can also give ‘information hand out’ for the patient to read mean while. If the patient agrees, set up FOBT in the room and write in your notes that patient's FOBT is due, for the doctor to see. The same applies breast exam, DRE, PSA and mammogram. After the screening tests are taken care of, enter the dates in the screening logbook with other data. As you used to do, document in the health maintenance flow sheet and also in the pro-format of the progress notes. Put the new current date next to the old date, and during the next visit you can use this date as an updated documentation.

This column you can add like a hand written column or a stamped imprint until you print new progress notes. See the example I mentioned. In 3/2002 if patient comes for a clinic visit you know the previous colorectal screening was done in 2/2001 and it is due now. A lot of time is saved for the doctor because he only has to clarify any questions patient has, and all the needed preparation like undressing the patient, keeping FOBT cards ready and in some cases providing necessary information to the patient are already taken care of, and the doctor has to only clarify the questions the patient has.

This practice works also for new patients who come in randomly and thus can be enrolled in your logbook. After getting entered the subsequent tracking can be done by the filing system. The simple measure of having the column of HM in the progress notes sensitizes the staff to look into this issue during every visit and after few weeks they get conditioned to doing it.

You should also be sensitive to the patient's age, and when a 50 year old is encountered, the patient has to be picked up as a new patient, if not entered already into the logging system.

The Filing and Tracking

The filing system not only documents the cancer screening in the file but also has an inbuilt tracking system that implements itself every month of the year on an ongoing basis. It enables you to focus your attention on these patients who have to come in every month at their yearly due times. As already discussed these are patient encounters are enrolled in different ways like:

1. Picked up from the computer generated patient list of 50+year old patients on which you worked (working) in a serial order.

2. Patients who don't want to come in but agreed for FOBT cards to be mailed.

3. Random visits to the clinic of the patients that are past due, non-compliant and missed appointment

4. High risk patients before age 50 and symptomatic patients on whom the doctor wanted to do DRE and/or FOBT or endoscopy (or PSA/mammography). Highlight these patients' names so that you will know if you see a patient less than 50 years old listed in the logbook.

5. New patients to the clinic—who agreed for cancer screening or patients from your own clinic when they become 50 years old

While enrolling the patients into the file, in the beginning you can keep loose sheets of these format pages near your chart filing cabinet, and when ever you have free time, can enter the information from the patients' charts following the alphabetical order of the computer generated list. Check off the patients' names in the list after you finish entering the data. More than one person can do this simultaneously i.e. one can work on patients in alphabetical group ‘A’ and the other with ‘B’. Actually you can separate the list into alphabetical clippings, so that different people can work simultaneously.

Enter the patient's name and other data on the top of the table. You can choose to write address when patient comes for clinic visit. You don't need to waste time on those who don't continue as your patients. Concentrate on the first column ‘The dates of last screening’. From the chart enter the dates of last FOBT, DRE, BE, endoscopy and PSA/mammogram.

Do not spend too much time finding dates for DRE and BE if they are not in the health maintenance flow sheet. For FOBT—it is good to note but if it is not in the flow sheet but is some where in the progress notes when the patient had annual physical or some other GI symptoms, don't worry about it. However you should have the dates for the PSA (either from the lab section or the HM flow sheet), previous mammogram and also previous endoscopy (includes sigmoidoscopy, colonoscopy or Barium enema either as a screening procedure or done for some GI symptoms). These three must be documented in the very first column of the table. If not done, mention that, and your current filing and future planning would be simple. Also note the age of the patient at the time of the previous endoscopy. The importance of this was explained already.

At the end of the day you can make the photocopies, and log these protocol tables into both cancer screening files into the corresponding months.

Endoscopy Reminder

We do endoscopy 5 years after the previous procedure irrespective of how we did FOBT in between. So for each patient when you are making screening table depending upon when the previous endoscopy was done, you calculate when the next endoscopy is again due five years later (i.e. If patients had it done on May 12, 1997 it is due again May 12, 2002). On another empty screening table just note the patient's name and DOB and in the endoscopy column write the date it is due, that is May 12, 2002 and file this in the May section of the file with page number 12. Highlight all the information—the date, patient's name & DOB and there is no other information documented in this sheet. It is just a reminder in May 2002 that patient is due for endoscopy which you can schedule around that time. If you don't do this way it can be almost six years when you plan for the next endoscopy because the FOBT may be delayed every year by 1 or 2 months endoscopy reminder makes the scheduling accurate i.e. exactly five years later.

Even though there is endoscopy reminder, after the results are back you have to document the ‘Date done’ and ‘Results’ in the endoscopy column of the patient's original record also. Again you create a similar reminder (this time for colonoscopy in some cases) for May 12, 2007 and keep in the May section. You encounter this every May, but you are acting on that only in May 2007 (or 2002 in previous reminder). You can choose to write the year also under the date in the right upper corner of the page, so that it can be immediately figured out that it is an endoscopy reminder.

If the patient misses the appointment, reschedule and file the patient's record in that part of the file just like the way you do for the other cancer screening procedures. You can also document about the missed appointment in the patient's original record. After few failed attempts, or if the patient refuses screening in the very beginning, your only choice is to try on this date again next year.

Because of the built in tracking ability of the file, reminders can be used for any information to be reminded of, at any particular date.

### Filing of Screening Tables within the Month Section

The Initial Dating and Filing

The information being described applies to both the cancer screening procedures.

After filing the records into the months of both the cancer screening files, the pages within the month needs chronological order so that scheduling and tracking will also follow the same order. So we need to assign page numbers to these patients' records in any particular month, that would be 1-31 (days of the month). It also should be chosen in such a way that you would know, when patient misses the clinic appointment. So the most logical choice is to choose the dates of the screening procedures that need clinic visits as the page numbers, about which I made a brief note already. FOBT, BE, DRE and PSA are the screening procedures that fall into this category. How ever, the assignment of the page numbers as mentioned is a general idea, but by no means strict, depending upon the clinical situation. This you will understand better in the later pages where I describe more about how to choose the page numbers for each cancer screening.

As mentioned, mark page numbers with pencil or pen (if you have ink eraser), because you change this often. Make note there can be more than one of certain numbers and some could be missing altogether i.e. those that fall on weekends and holidays.

In the initial filing after you mark the page numbers, you will realize there is no serial order to the page numbers in any month because you followed the alphabetical order of the computer list. Try to arrange the serial order of the month pages at the end of the day when you try to log in the patient records you made on any day. Once certain order is restored, you need to figure out where each page has to go to, as per the page number. Imagine an old book with loose pages, and by accident the pages are mixed up and you are supposed to arrange the book into order again looking at the page numbers. It is similar but simpler because you are only dealing with 31 pages in any month. Suppose you have to add page 20, it goes between page numbers 19 and 21. So from now on, instead of adding in a random fashion you have to look at the existing pages and add where it belongs to.

Restoring the chronological order is important before you start scheduling. As soon as you assign page number it has to be entered into the patient index also. Otherwise there is no way how you find where the patient's record is, when you need to. You can also add some of the patients you see in the clinic as regular appointments (not necessarily non compliant or missed appointments. These could be the patients whose screenings are current but you just happened to see them as a clinic visit). You need to avoid duplication of filing (you could have already entered the patient). You can figure it out if you make a note of which alphabetical groups you already finished. How ever, you need to look at the patient index to find where the patient record is, instead of looking at the screening dates in the chart to figure out which month it is filed into.

The Tracking

On any particular month, when it becomes current, the patient records that are there on any date, are the patient appointments you deal with on that day i.e. these page numbers are like calendar days of that month and on any particular day, looking at these page numbers you know who are coming that day. You will know on the same day if patient misses the appointment, so that you can call and reschedule. This is the inbuilt tracking system that the file implements itself without any extra effort from you.

### The Initial Appointments

While you are still working on the file, you can start scheduling some of the patients that are entered into the current month. The page number assigned is the date you need to give as an appointment. If the date is not convenient to the patient and if you reschedule, you need to change the page number, and move this to that part of the month. Once an appointment is given, put a boldly visible dot next to the page number to differentiate from the ones whose appointments are not yet taken care of. If the patient misses the appointment mark the rescheduled date without changing the dot. It stays until the screening is done and when you are ready to conclude the month. This simple technique has to be followed whenever you are giving appointments for patients during any month. Other wise there will be a mix up of the patients' appointments (with the ones that are not given appointments). Try to rearrange the month's file in the chronological order (serial order) as per the page numbers only after all the patients' appointments are taken care of. It may not be very much feasible in the beginning when you are still making the file. But this rule can be best followed once you finish filing the whole computer list and start scheduling the patients 1 or 2 months in advance.

While you are still making the file new patients can be adding up to the current month every day from the computer list or from the clinic visits (the clinic patients could be the ones whose screening could have been done on a current date during the regular clinic visit. When they were added to the file to maintain uniformity dot these pages also so that you will not try to call to schedule them again.

You can schedule only certain number of patients on any given day. Put a tab to the page whenever you are interrupted from scheduling in the middle of or at the end of the day so that you will know where to start again. The color of this tab should be different from the mammography and the endoscopy tabs, about which you will read in the next few pages.

Try to look into both the cancer screening files and see if you can couple the appointments and schedule all the clinic screening tests (FOBT, DRE, BE, PSA) on the same day. You should also be able to schedule for endoscopy and mammography around this date. While scheduling make sure they all are after one full year from the date of previous screening (previous date + at least 1 day). Skip the holidays. It is a good idea to have a photocopy of the current year's calendar in the beginning of each month's section.

The Coupled Sheduling

The clinical screenings—DRE, FOBT, BE/PSA are interrelated and can be conveniently done as ONE TIME clinic screening, because it is cost effective for the time, effort and clinic visits involved. It is also convenient because you need to have the nurse present, and the patient undressed while doing all these. So COUPLING and doing both the cancer screenings in one visit is ideal. For patients who are regular for clinic appointments, check both files as previously mentioned, and try to give the appointments on the same day.

However as you already know even for coupled screenings, you are documenting the scheduling, the date done, and the results in separate cancer screening files, using the relevant cancer screening table, and the patient index, which is also separate for both the files.

### How to do the Regulate Appointments

On a regular basis, for any month, you need to start scheduling 1-2 months ahead (especially for the mammogram and endoscopy). As you did for current month filings (when you are still in the process of filing) you need to restore the chronological order (serial order) of the pages while filing, which makes the scheduling easier. You already entered these patients' names into the patient index at that time. Use the dot to the page numbers, and also the tab as described before at the time of scheduling. Rearrange the page numbers of the file into the right serial order only after all the appointments are taken care of, which should be feasible because you are scheduling 1 to 2 months in advance. Also change the page numbers in the patient index.

After changing the page numbers repeatedly in the screening table, if you think the right upper corner of the page is not usable any more, make a new photocopy of that page.

When the month becomes current, if the patient doesn't keep up the clinic appointment, you need to reschedule. Change the page number and move the record to the later part of the month or the next month. Even if it is located in a different month, because it's appointment is already taken care of, the dot stays, until you conclude the month where it is located.

When you call for the reappointment you can ask if the patient kept up (or going to keep) the procedural appointment (mammography and endoscopy).

1. If you find patient is going to keep up the appointment for mammogram—Don't insist too much about the BE. However give 2^{nd} appointment date and document because you can't be too certain that she would go for mammogram.

2. If is the year for endoscopy and if the patient is going to keep up the appointment—Don't insist on clinic visit (mail FOBT cards & document)

3. If it is the year for FOBT only—you need to insist. Mail FOBT cards and insist the patient to return them in 1 wk (document).

4. For PSA also you should insist, and give an appointment (this is the one you really need to try for 3^{rd} appointment also). Patient can have DRE also during that visit. You can give 3^{rd}

5. appointment especially for PSA and after that, document as ‘Refused’ or M (missed appointments) in ‘Date done’ section.

You should also insist for endoscopy when it is due, that is every 5 years and also for mammography because these are the definitive diagnostic procedures.

For missed appointments after repeated efforts, your only choice is to try again next year, unless you find them during a random visit during which time patients' records can change to a different month of the file. So during a current month period there will be rescheduling, change of page numbers and also moving of pages into the future dates of the month which is an active updating that also has an inbuilt tracking devise to find the missed appointments precisely on the same day.

After the endoscopy and the mammography results are back, document the results and mark these procedural dates as page numbers and the Colorectal and Breast cancer screenings (FOBT, BE and mammogram) next year will be after these dates irrespective of the preceding BE and FOBT dates. Also move the patients' records to that date of the month when these definitive procedures are done. You will read more about this in the later pages.

This concludes each month. However make sure there are no dots next to the page numbers at this time because they have to be marked again next year when the appointments are being given. The month stays dormant until the next year, when you come back to this month again to start scheduling appointments (preferably 1-2 months earlier) in the way described already. Next year also you can check the pages for the dots before you start scheduling.

### How do you Follow up and Document the Results

The results of the clinic screenings you document on the same day (except PSA) both in the file And the health maintenance flow sheet in the chart. Only the endoscopy and mammography results are delayed by one or two weeks. When you get them enter the results in the table and also collect them as a clipping to keep at the end section of the file (for the doctor to review at the end of the month). Highlight the abnormal reports and if you choose to, write a brief note also in the back of the page. How ever you have to write a detailed report in the ‘Abnormal reports’ section in the back of the file (You will see the table for the abnormal reports in the next few pages). You also have to document the endoscopy report in the original record of the patient even though there is an endoscopy reminder elsewhere. At the time of scheduling you can note down the names and phone numbers of the hospitals the patients are referred to, in the back of the page so that you can call if the reports are delayed.

In any particular month you have to put small detachable tabs to the female patients' records that were scheduled for Mammogram. When you receive the report you can remove the tab. If the tab stays that mean the patient has not kept the appointment or the report is missing. Call and reschedule if the patient has not kept the appointment.

You can have tabs for endoscopy also when it is scheduled, that is once in 5 years (remember these tabs should look different from the tab you use when interrupted while scheduling).

The follow up of the results and tracking the delayed ones also can be easily done this way.

How Do You Change the Page

After 5 years (also can be more or less than 5 years) you need to add a fresh page. At that time the old record doesn't need to be there in the file. How do you make this transition? Using the old record, schedule the patient appointments for your clinic, and also for outside procedures and note down the information in the ‘Scheduling’ and the ‘Scheduled dates’ columns of the fresh page you started. Save the old record in a ‘saving file’ assigned separately for all the old records. Note the new appointment as the page number for this fresh page, if changed from before, and file in as per its page number.

This is also the year for endoscopy for all the patients. Change of the page is also an approximate endoscopy reminder. You must have encountered the filed ‘endoscopy reminder’ already (much earlier, because it is exact 5 yrs. reminder) which might have been scheduled.

Document the results in the original record & create another endoscopy reminder. There is a transitional column in the table after column 5 prompting you to read this text before changing to a new page. The old records can be saved in the ‘saving file’

### Other Important Aspects of Filing

You need to start calling 1-2 months earlier to be able to get the appointment date.

Let us start with May 2002. You should have called them for appointment starting March or April 2002 and fill in the ‘Scheduling’ column. This can continue into the month of May also. As the patients come in and FOBT, BE, DRE or PSA are being done, fill in ‘Date done’ section also.

For patients whose endoscopy, PSA or mammograrn results are pending, the ‘Results’ column should be filled in by the end of May and June. If there is any abnormal report, highlight it after writing [AB] and enter the detailed reports (radiology, pathology or consultants' reports) in the abnormal reports section. After all the reports are entered, and the filling of the table is complete the doctor has to review them. He has to see all the original pathology reports or consultants letters collected for that month. It does't take lot of time. You (the doctor) only have to quick scan for the abnormal reports and make sure these abnormal reports are correctly entered into the file. You can also make use of this opportunity for subsequent plan for these abnormal reports if they were missed previously, by any chance. All the abnormal reports have to be entered into abnormal reports section also (to be maintained separately for breast, colorectal and prostate cancer screening) and at the end of the month you have to write ‘Reviewed’ and sign it. This is the only way you can be sure of not missing abnormal reports by misplaced charts from your office table. It can happen. Your staff can keep a pile of charts for the lab reports to be reviewed by you and signed. You might have come across 3-4 abnormal reports. Some times you may not get the patient on the phone right away, and you can keep these charts aside to call again. The next day few more charts like this can accumulate before you could actually get in touch with the patients. Meanwhile one of your staff members could be looking for one of these charts for some other reason and can take it from your table and can forget to keep it back or can keep it in a different pile on your table (the one you finished and to be returned to the filing cabinet). If you are busy you may not realize a missed chart after 3-4 days. You may think you have contacted all the patients and may not realize that you missed 1 or 2. So carefully documenting the abnormal reports and reviewing & signing it at the end of the month will protect you from any adverse consequences.

This ends the section of May 2002 and you will come back to this section again in May 2003 to take care of the same set of patients entered already. New patients would have been added to the list and it keeps growing every year and all through the year. You are only using one column of the table for every year and you can use this table ideally for a maximum of 5 years. (It can be less than that for some patients and can be more for postponed & missed appointments). After that you start a fresh page

### Patient Index

The patient index is the first section of this file. I chose not to write details about it in the beginning because this is the time you will understand better how it works. Patient index helps you locate the information of any particular patient in the file. Each cancer screening section has it's own patient index.

Patient index has patients' names arranged in alphabetical order A-Z, one page allotted to each alphabet. Under each alphabet patients' names are in serial order as the patients are entered. See the patient index table-3 in the following page.

The patient index is divided into two different columns. The first and the smaller column contains the patients' names and DOB. The second wider column is for location of patient records—with month and page numbers (month first & Page number after, just like we write the date. It is easy to remember that way). This column is again divided into smaller columns to write the month and page number each time the page number changes. If the patient's name and screening information is in the month of January and if the page number is 25, you put 1/25 in this column. So if you want to know where the patient's information is, you can refer to the patient index and find it. Again when the page number changes you write this month and new page number in the next column. So the last date noted in these columns tells you where the patient's record is. It also tells when the patient's next appointment is or when the most

[image]

Recent Appointment Was.

When ever the columns are filled up for any patient's name, you have to add new patient index page filed adjacent to the existing page. You can write only that patient's name in the new patient index page. After the old sheet is completely filled in you can take it out of the file.

Clinics that are busy may find the patient index rather cumbersome and confusing, to fill in the squares during each appointment. It is also a good idea to write the appointment dates in the patient index with a pencil and change it with the new date, each time the patient has a new appointment, such that there will be only one date marked for each patient, at any time

High Risk Patiets

High risk patients start screening earlier than age 50. The doctor will decide it by the patient's History, physical exam and relevant GI symptoms. These patients are also listed in the screening file before age 50 for close follow up. If you don't enter them into the logbook there is no other way to schedule them for necessary cancer screening every year, or any other time frame required. Highlight these patients with a chosen color.

Saving File

The old records of the patients can be saved in a saving file with file tabs from A-Z. You have to refer this file for any old information you need. Within each alphabet the filing is not in alphabetical order, but in a serial order. Mark that number on the top of the page as you are filing. Mark the same serial number in the middle of the top of the new page—for cross-reference (alphabet followed by the serial number) After many years there can be more than one old record for any given patient, but mark the same serial number to each patient. File them next to each other and mark the same serial number on the top of the page for cross-reference. You can also staple them together. There can be patient index for each alphabetical section where the patient's names and page numbers can be entered as the patient records are filed into the saving file.

### Cancer Screening—More About How to do it

This section is more precisely about the individual cancer screenings. It deals with the features unique to each of these screenings and also about how you choose page numbers in different situations.

Colorectal Cancer Screening

1. It is only FOBT every year and endoscopy every 5 years. File on the date the previous screening test (current) was done. If an endoscopy is due, make an endocopy reminder and schedule

2. If not current

(a) If due for endoscopy (previous endoscopy 5 yrs. before or never done)—Schedule and make an endoscopy reminder (You may not need endoscopy reminder if the scheduling is the first time. But to avoid confusion especially if it gets postponed and also to maintain uniformity, you can still make one and file on that date). Meanwhile call patient for clinic appointment for FOBT, and use this as the filing DATE and MONTH. How ever when endoscopy is done change the page number to this date (see below). If you are not confident that the patient may not keep up the appointment insist about FOBT if it was done more than a year ago, and also plan for mailing the cards to the patient. However after an endoscopy is done, a reminder has to be made again, and filed in that date and month, so that it would not be interfered with, what ever be the course and filing of the original record that is monitoring the FOBT.

(b) If due for FOBT—Schedule and use this as the filing DATE and MONTH. If the appointment is postponed move the record to the rescheduled date and also plan to send FOBT cards.

3. New patients, or never done patients—They are due for endoscopy. Do as described above.

4. For past due patients, schedule which ever is due and file in that appointment date.

5. After an endoscopy is done, the next FOBT should be 1 yr after that date, irrespective of the date of FOBT prior to endoscopy. The current endoscopy overrides the FOBT date preceding that—for whatever reasons the endoscopy was done. So change the previous page number to current endoscopy date and move the patient's record to that date for the next FOBT to be done 1 year later. How ever this situation is only every 5 years or less than 5 years if endoscopy is done in symptomatic patients. During the other years the FOBT date would be the only DATE and MONTH of filing endoscopy being done every 5 years, is for healthy average population for screening, and it can be more frequent for patients with gastrointestinal pathology.

6. If a patient is rescheduled for endoscopy, move the ‘endoscopy reminder’ to the rescheduled date. You can make few attempts and after that it stays in the last appointment date and the only course you have is to try again next year. You should also try to make efforts to find these patients during random visit to convince for an endoscopy. During a visit, you need to figure out which is due to be done for that patient.

Mailing FOBT cards—Sick elderly patients may not like FOBT done even during a random visit depending upon their level of discomfort. You can make use of the opportunity of mailing the cards as soon as the patient misses the appointment so that you don't need to bother about repeated appointments. In fact if you identified habitually non-complaint, sick or elderly patients, just mail them cards on the due date every year. Instruct them clearly each time. Also mail written instructions. At the end of the month you should check if the results column is filled. If not the patient has not returned the cards. You should call and remind the patient.

Tracking

Whenever patient misses the appointment date (which is the page number) you know on the same day and can call and reschedule.

### Breast and Prostate Cancer Screening

Breast Cancer Screening

1. If mammogram is current—File on that DATE and MONTH.

2. If not current—Schedule and file in that MONTH. Meanwhile also schedule for Breast exam in the clinic, and file on that DATE.

You can use BE as the DATE and mammogram as the MONTH of the filing. But every year when mammogram report is back you can use that date as the page number for subsequent BE and Mammogram scheduling. In other words current mammogram date over rides previous BE date. You may save 1-2 months like that every year if mammogram gets postponed.

If BE and mammogram are scheduled for different months, the patient's record is still filed in the month of BE, with a detachable tab to indicate that the patient had an appointment for a mammogram.

The page number is only a guideline to schedule and follow up clinic appointment for BE. Now you can schedule clinic appointment for BE on the date of the preceding year's mammogram. So each year the BE takes up the previous Mammogram date. (So when mammogram report returns change the page number to the date it was done, which would be next year's clinic appointment for BE. (unless patient comes to the clinic with breast symptoms). Next year when you try to call patients for appointments 1-2 months earlier, try to schedule mammogram date also immediately after this date. When only BE is done It's date remains as the DATE and MONTH of filing and also subsequent appointment date.

Patients who are non-complaint for multiple reasons (no insurance, elderly and non compliant by nature)—you can find them during random clinic visits (through the H.M. column in the progress notes) and insists on breast exam.

Prostate Cancer Screening

With prostate cancer screening the choices are simpler and easier. It is because both PSA and DRE are done in your clinic and most probably on the same day. So obviously it is going to be the DATE and MONTH of filing. Some times patients come for symptoms and can have DRE done. If patient has PSA done after this date the subsequent DRE would be 1 yr from this date (unless the patient is symptomatic and needs DRE). So here also the PSA date overrides the previous DRE date.

If PSA screening date gets postponed the page moves to rescheduled date.

If the PSA and DRE are past due or never done, schedule and file in that date. PSA is the clinic screening you should really insist and can give up to 3 appointments before labeling as non compliant to try again only the following year.

Coupling

You can always try to couple these screenings during one clinic visit. As already mentioned for patients who are regular for clinic appointments, check both files and try to give appointment for BE/PSA, DRE and FOBT on the same day. In the future if they dissociate don't worry about that.

I also mentioned already that each filing has its own patient index and you need to document each time the page number changes.

Similarly for new patients (patients who had 50^{th} birth day recently and patients that are new to the clinic), past due and never done patients, you can take the opportunity of coupling to screen on the same day and also can talk about scheduling procedural screening for endoscopy and mammogram during one phone call to the patient. Compliant patients can keep up this coupled clinic appointment every year, which they would actually appreciate.

So it is a good idea to check the other filing also every time you are scheduling a patient. You may find an opportunity to couple missed appointments that are past due for either one or both the cancer screenings.

If the patient is elderly and has chronic medical problems and can't keep up the scheduled clinical appointments you have to try to do cancer screening when they come for random clinic visit for unrelated problems. However you have to be careful and sensitive to the patients' ailments, because some patients may not want to have screening procedures done during random visit also because they are sick and may resent any other unrelated testing. However you should always try to make use of the opportunity without causing too much discomfort to the patient.

Abnormal Reports

See the abnormal reports table 4. As already mentioned there should be separate section for this. See the ‘Abnormal reports’ table in the filing section. The abnormal reports for each cancer should be filed separately. Note the MONTH and YEAR on the top of the list. It has 4 vertical columns to mention—patient's name and date of birth (DOB), date of abnormal report, and the abnormal report column to mention the report as it is exactly reported, and finally the column for the definitive treatment done,. The doctor has to sign it at the end of the month.

Other Additions

You can add sections like ‘To do list’ for any particular month. You can also have a section for ‘Issues to discuss during staff meeting’.

In the ‘Filing section’ after this text, there is a ‘work sheet for the month’ you can put in the beginning of each month section to use while you are calling for appointments (to note down about patients when you can not reach by phone and need to call again). You can also use it for other purposes like trying to call the patients about the results. You can round off whatever purpose you are using the work sheet for. Issues that would not fit into the ‘work sheet’ can be done as the reminders.

Annual Physicals

You can use this tracking system for annual physical also for patients age 50+.

Legal Protection

Documentation like this protects you from a lawsuit from a non-compliant patient who may have cancer and identifies you the physician. You need to document (R)—for refused appointments and also 1-2 reschedules you made, for your own protection.

Other Filings

There are similar filings available for Cervical caner screening and also for childhood immunizations.

Conclusion

This filing is devised to relieve the Primary care physicians from the stress of the immense responsibility of the Health—maintenance that seems to be simple, but very difficult in real practice. Filing like this facilitates the participation of the whole clinic and the ‘Connectedness’ makes every body sensitive to diligent implementation of the protocol that is made easier by shared responsibility.

[image]

[image]

[image]

[image]

[image]

[image]

[image]

[image]

[image]

[image]

[image]

[image]

[image]

[image]

[image]

1. The method of breast/prostate and the Colorectal cancer screening system, where in, the cancer screening protocol is comprised of breast exam (BE), and mammogram every year for breast cancer screening, the PSA, and DRE testing for Prostate cancer screening, and for Colorectal cancer screening, it is fecal occult blood testing every year and endoscopy every 5-10 years, all these starting age 50, flexibility of this routine being exerted at the discretion of the physician, usually initiating the screening earlier for high risk population.

2. The method of claim 1, where in, the screening can be initiated by generating a computer patient list, and selecting population 50 and above, to call them for cancer screening, those past due, (more than an year), and never had screening, being given the priority of appointment, and the DATES or MONTHS, they had the clinical cancer screening (for screening done in the clinic like PSA, BE, DRE, and FOBT, in contrast to the mammography and endoscopy that are done out side the clinic) during the past year, or the current year, serve as the page number noted with a pencil, and the record filed into that date and month.

3. The method of breast/Prostate, and Colorectal cancer screening, where in, when the initial filing is being done by documenting the patient data, and the previous cancer screening information for both the screenings (information obtained from the chart or the patient), in the same cancer screening table, a photocopy can be made, and filed in both the cancer screening divisions of the file.

4. The method of breast/Prostate and Colorectal cancer screening system, where in, the upper half of each cancer screening table in the cancer screening information section contains the Colorectal cancer screening, and the lower half has the breast/Prostate screening, each screening has detailed columns to document information about current screening that includes the scheduling dates, date the screening done, and the results for FOBT, ENDOSCOPY, DRE, BE, and MAMMOGRAPHY, the table having provision to document 5 years of screening.

5. The method of cancer screening of claim 1, where in, there is a provision for coordinating the screening of non-compliant patients during random visits, the opportunity being facilitated by having the health maintenance column in the progress notes, wherein, along with the rest of the data like BP., pulse, and wt., there are spaces to document the last dates of cancer screening for the breast, prostate and Colorectal, so that if they are past due, the patient, if agrees, can have screening done screening for early detection, and to try for the mammography and endoscopy also scheduled.

6. The method of cancer screening system of claim 1, where in, there is a provision for accurate endoscopy scheduling, in 5 years from the previous procedure, by having ‘endoscopy reminder’, which is separate from the patient's original cancer screening record, and in the reminder, which is also the similar cancer screening table, under the endoscopy column, the date and the year of the next endoscopy due, is noted, and filed in that month, with that date as the page number, and the reminder can be encountered every year during that month, but can be acted on only in the year the appointment is scheduled.

7. The method of cancer screening system, of claim 1, where in, after the appointment is given, a dot is put next to the page number, to avoid mix up with the pages that were not given appointments, and after finishing the scheduling of all the patients, before the 1st of the month, these pages have to be arranged in serial order (1-31), so that the ones with the appointments on the first, will be in the opening pages, and will be noticed if the appointment is missed, and thus on any current month or day, that particular months records have to be focused on, and if the patients are rescheduled, the page number has to be changed with out changing the dot, and the patient's record filed in the new appointment date, and the dot stays until the month is concluded.

8. The method of cancer screening system of claim 1, where in, due to co existent screenings in one file, and also because the screening tests involved can be conveniently combined and done as ‘one time’ clinic screening, checking both the files and giving ‘coupled’ appointment on the same day, is cost effective and convenient.

9. The method of breast/Prostate and Colorectal cancer screening system where in, in the protocol devised, the endoscopy over rides the FOBT preceding it, and so after an endocopy is done the next FOBT should be 1 year after that date irrespective of the date of the FOBT prior to the endoscopy, and hence after an endoscopy is done, the patient's cancer screening record is to be moved to the current endoscopy date, for the next FOBT to be done 1 year later as a screening procedure, though this situation occurs only once in 5 years, or less if an endoscopy is done as an emergency procedure in a symptomatic patient.

10. The method of breast/Prostate and Colorectal cancer screening system, where in the protocol is devised such that, the mammography date overrides the preceding BE date and after the mammography is done, the patient's record has to be filed in that date so that the next BE as a cancer screening, can be safely done 1 year after this date, irrespective of when the breast exam was done preceding the current mammography.

11. The method of breast/Prostate and Colorectal cancer screening system, where in, the protocol is devised such that the date of the PSA over rides the date of the DRE, and after PSA is done, the patient's record is filed in that date, and the DRE, as a screening can be safely done 1 year later, irrespective of when the DRE was done preceding the current PSA, but under normal circumstances, the PSA and the DRE are usually done on the same date.

12. The method of claim 1, where in the instructional manual is supplied with a file compilation section, that has tabs, file dividers, and tables, that can be used to construct the file, which other wise would be difficult to initiate, for any average busy practitioner.
